(19) United States
(12) Patent Application Publication
(10) Pub. No.: US 2022/0410929 A1
(43) Pub. Date: Dec. 29, 2022

(54) AUTONOMOUS VEHICLE, CONTROL SYSTEM FOR REMOTELY CONTROLLING THE SAME, AND METHOD THEREOF

(71) Applicants: Hyundai Motor Company, Seoul (KR); Kia Corporation, Seoul (KR)

(72) Inventor: Dong Hyuk KIM, Hanam-Si (KR)

(73) Assignees: Hyundai Motor Company, Seoul (KR); Kia Corporation, Seoul (KR)

(21) Appl. No.: 17/546,462

(22) Filed: Dec. 9, 2021

(30) Foreign Application Priority Data
Jun. 25, 2021 (KR) 10-2021-0083396

(51) Int. Cl. B60W 60/00; B60W 40/04

(52) U.S. Cl. CPC B60W 60/005; B60W 40/04; B60W 60/001; B60W 2556/10; B60W 2556/50

(57) ABSTRACT

An autonomous vehicle may include an autonomous driving control apparatus including a processor that is configured to request remote control of the autonomous vehicle to a control system when the remote control of the autonomous vehicle is required, and when receiving a driving path stored during a previous remote control of the autonomous vehicle from the control system, follows and controls the received driving path.

### CROSS-REFERENCE TO RELATED APPLICATION

The present application claims priority to Korean Patent Application No. 10-2021-0083396, filed on Jun. 25, 2021, the entire contents of which is incorporated herein for all purposes by this reference.

### BACKGROUND OF THE INVENTION

### Field of the Invention

The present invention relates to an autonomous vehicle, a control system for remotely controlling the same, and a method thereof, and more particularly, to a duplicate remote control request when the control system remotely controls the autonomous vehicle.

### Description of Related Art

As an electronic technique of a vehicle develops, an interest in an autonomous vehicle that drives to a destination by recognizing a driving environment of the vehicle itself without manipulation of a driver is growing more and more.

An autonomous vehicle refers to a vehicle capable of operating by itself without manipulation of a driver or a passenger.

While driving in an autonomous driving mode, there may be a situation in which it is impossible to follow a driving path to the destination normally although there is no abnormality in a function of the vehicle. Accordingly, when a situation where it is impossible to follow a path occurs during autonomous driving, it is often difficult to follow the driving path, such as when the driver directly intervenes in control of the vehicle or when the driver's intervention is difficult, the vehicle stops.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an autonomous vehicle, a control system for remotely controlling the same, and a method thereof, configured for remotely controlling the autonomous vehicle based on a previous remote driving path when the autonomous vehicle requests redundant remote control to the control system at a same position thereof.

The technical objects of the present invention are not limited to the objects mentioned above, and other technical objects not mentioned may be clearly understood by those skilled in the art from the description of the claims.

Various aspects of the present invention are directed to providing an autonomous vehicle, including an autonomous driving control apparatus include a processor that is configured to request remote control of the autonomous vehicle to a control system when the remote control of the autonomous vehicle is required, and when receiving a driving path stored during a previous remote control of the autonomous vehicle from the control system, follows and controls the received driving path.

In various exemplary embodiments of the present invention, the autonomous vehicle may further include a communication device configured to communicate with the control system.

In various exemplary embodiments of the present invention, the processor may transmit at least one of vehicle position information, vehicle surrounding image information, or vehicle surrounding information to the control system through the communication device when requesting the remote control to the control system.

In various exemplary embodiments of the present invention, the vehicle surrounding information may include at least one of obstacle information, moving vehicle information, or stationary vehicle information.

In various exemplary embodiments of the present invention, the processor may determine a drivable area based on the driving path received from the control system.

In various exemplary embodiments of the present invention, the processor may modify the driving path received from the control system according to information of a host vehicle and a possibility of collision.

In various exemplary embodiments of the present invention, the processor may generate a path according to a remote control command to follow and control the generated path when receiving the remote control command from the control system, and may transmit the generated path to the control system when the remote control is terminated.

Various aspects of the present invention are directed to providing a control system including a processor configured to determine whether there is a previous remote control history of a vehicle overlapping within a predetermined distance from a current position of the vehicle requesting remote control upon receiving a remote control request from the autonomous vehicle, and when there is the overlapping previous remote control history, to transmit a driving path corresponding to the overlapping previous remote control history to the autonomous vehicle.

In various exemplary embodiments of the present invention, the processor may receive vehicle position information, vehicle surrounding image information, and vehicle surrounding information from the vehicle requesting the remote control.

In various exemplary embodiments of the present invention, the processor may compare obstacle information around the vehicle requesting the remote control with obstacle information stored in the previous remote control history.

In various exemplary embodiments of the present invention, the processor may determine whether a stationary object or a moving object exists on a driving path stored in the previous remote control history.

In various exemplary embodiments of the present invention, the processor when the moving object exists, may determine whether the moving object is movable in the future.

In various exemplary embodiments of the present invention, the processor may determine whether the moving object is movable by determining whether there is a history of movement of the moving object while the moving object is stopped.

In various exemplary embodiments of the present invention, the processor, when the obstacle information around the vehicle requesting the remote control matches the obstacle information stored in the previous remote control history, the fixed object or the moving object does not exist on the driving path stored in the previous remote control history, may determine that the remote control request and the previous remote control history overlap with each other, and may transmit the driving path stored in the previous remote control history to the autonomous vehicle.

In various exemplary embodiments of the present invention, the processor, although the moving object exists, may determine that the moving object is movable in the future when there is a history of movement of the moving object while the moving object is stopped, and may determine that the remote control request and the previous remote control history overlap with each other.

In various exemplary embodiments of the present invention, the processor, when there is a remote control history within the predetermined distance from the current position of the vehicle requesting the remote control, the obstacle information around the vehicle requesting the remote control matches the obstacle information stored in the previous remote control history, there is no fixed object on the driving path stored in the previous remote control history, and the driving path is currently drivable, and there is a moving object which is movable in the future on the driving path stored in the previous remote control history, may determine that the remote control request and the previous remote control history overlap with each other, and may transmit the driving path stored in the previous remote control history to the autonomous vehicle.

In various exemplary embodiments of the present invention, the processor when there is a plurality of previous remote control histories, may set a higher priority for a latest driving path, a path with a shortest driving time, and a driving path of a same vehicle type as that of the vehicle requesting the remote control.

In various exemplary embodiments of the present invention, the processor may further include a storage configured to store a remote control history received from the autonomous vehicle after terminating the remote driving.

Various aspects of the present invention are directed to providing an autonomous driving method, including: receiving a remote control request from the autonomous vehicle; determining whether there is a previous remote control history overlapping within a predetermined distance from the vehicle requesting remote control; and transmitting a path corresponding to the overlapping previous remote control history to the autonomous vehicle when the overlapping previous remote control history exists.

In various exemplary embodiments of the present invention, the determining of whether there is the overlapping previous remote control history may include: when there is a remote control history within the predetermined distance from the current position of the vehicle requesting the remote control, the obstacle information around the vehicle requesting the remote control matches the obstacle information stored in the previous remote control history, there is no fixed object on the driving path stored in the previous remote control history, and the driving path is currently drivable, and there is a moving object which is movable in the future on the driving path stored in the previous remote control history, determining that the remote control request and the previous remote control history overlap with each other; and transmitting the driving path stored in the previous remote control history to the autonomous vehicle.

According to the present technique, it is possible to reduce hassle of repeatedly performing a same remote driving mode by providing an autonomous vehicle with a driving path traveled by a same vehicle type in a same position as those of the autonomous vehicle when a control system remotely controls the autonomous vehicle.

Furthermore, various effects which may be directly or indirectly identified through the present specification may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram showing a configuration of a remote control system for an autonomous apparatus according to various exemplary embodiments of the present invention.

FIG. 2A illustrates a view for describing a sensing device of an autonomous vehicle according to various exemplary embodiments of the present invention.

FIG. 2B illustrates a sensing range of a sensing device of an autonomous vehicle according to various exemplary embodiments of the present invention.

FIG. 3 illustrates a view for describing a process of determining whether to request remote control of an autonomous vehicle according to various exemplary embodiments of the present invention.

FIG. 4 illustrates a view for describing an example of a screen which is displayed in a control system based on information received from an autonomous vehicle according to various exemplary embodiments of the present invention.

FIG. 5 illustrates a view for describing a process of checking duplicate remote driving data by a control system according to various exemplary embodiments of the present invention.

FIG. 6 illustrates a view for describing a process configured to perform obstacle avoidance driving based on a path received from an autonomous vehicle according to various exemplary embodiments of the present invention.

FIG. 7 illustrates an autonomous control method for a vehicle according to various exemplary embodiments of the present invention.

FIG. 8 illustrates a computing system according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, some exemplary embodiments of the present invention will be described in detail with reference to exemplary drawings. It should be noted that in adding reference numerals to constituent elements of each drawing, the same constituent elements have the same reference numerals as possible even though they are indicated on different drawings. Furthermore, in describing exemplary embodiments of the present invention, when it is determined that detailed descriptions of related well-known configurations or functions interfere with understanding of the exemplary embodiments of the present invention, the detailed descriptions thereof will be omitted.

In describing constituent elements according to various exemplary embodiments of the present invention, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which various exemplary embodiments of the present invention pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

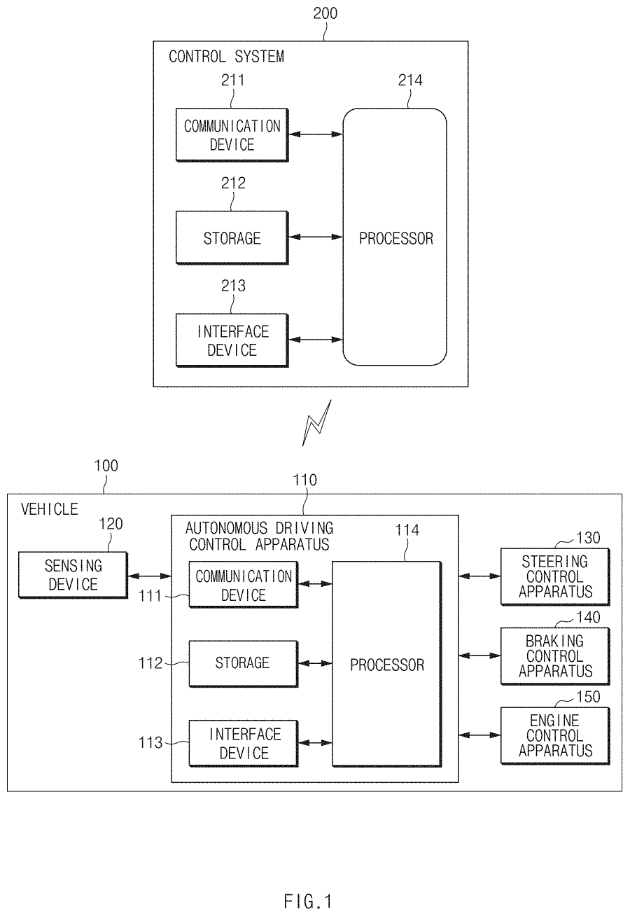

Hereinafter, various exemplary embodiments of the present invention will be described in detail with reference to FIG. 1 to FIG. 8.

FIG. 1 illustrates a block diagram showing a configuration of a remote control system for an autonomous apparatus according to various exemplary embodiments of the present invention.

Referring to FIG. 1, the remote control system for an autonomous vehicle according to various exemplary embodiments of the present invention includes a vehicle 100 and a control system 200, and remote control may be performed through communication between the vehicle 100 and the control system 200. In the instant case, the vehicle 100 may include an autonomous vehicle.

The vehicle 100 may include an autonomous driving control apparatus 120, a sensing device 120, a steering control apparatus 130, a braking control apparatus 140, and an engine control apparatus 150.

The autonomous driving control apparatus 110 according to the exemplary embodiment of the present invention may be implemented inside the vehicle. In the instant case, the autonomous driving control apparatus 110 may be integrally formed with internal control units of the vehicle, or may be implemented as a separate device to be connected to control units of the vehicle by a separate connection means.

The autonomous driving control apparatus 110 may transmit vehicle data for remote control to the control system 200 in the case of a situation where the remote control of an autonomous vehicle is required, and when receiving an existing driving path or a remote control command for remote control from the control system 200, may perform driving control based on the received driving path or may generate and follow a path based on the received remote control command.

Referring to FIG. 1, the autonomous driving control apparatus 110 may include a communication device 111, a storage 112, an interface unit 113, and a processor 114.

The communication device 111 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, Local Interconnect Network (LIN) communication, flex-ray communication, Ethernet communication, and the like.

Furthermore, the communication device 111 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like. For example, the communication device 111 may perform wireless communication with the control system 200, may transmit vehicle position information (e.g., vehicle coordinates), surrounding information (e.g., obstacle information), vehicle information (e.g., overall length and width of a host vehicle), a remote control request, etc. To the control system 200, and may receive a driving path, a remote control command, and the like from the control system 200.

The storage 112 may store sensing results of the sensing device 120, information received from the control system 200, data and/or algorithms required for the processor 114 to operate, and the like.

As an example, the storage 112 may store vehicle information, a vehicle driving path, image data captured by a camera, and a remote control command received from the control system 200.

The storage 112 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 113 may include an input means for receiving a control command from a user and an output means for outputting an operation state of the autonomous driving control apparatus 110 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display.

The interface device 113 may be implemented as a head-up display (HUD), a cluster, an audio video navigation (AVN), a human machine interface (HM), a user setting menu (USM), or the like.

For example, the interface device 113 may display data transmitted and received with respect to the control system 200, a driving path of the vehicle, a remote control command or a driving path received from the control system 200, and the like.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

The processor 114 may be electrically connected to the communication device 111, the storage 112, the interface device 113, and the like, may electrically control each component, and may be an electrical circuit that executes software commands, performing various data processing and determinations described below.

The processor 114 may process a signal transferred between components of the autonomous driving control apparatus 110, and may perform overall control such that each of the components can perform its function normally.

The processor 114 may be implemented in a form of hardware, software, or a combination of hardware and software, or may be implemented as microprocessor, and may be, e.g., an electronic control unit (ECU), a micro controller unit (MCU), or other subcontrollers mounted in the vehicle.

The processor 114 may determine a situation in which remote control of the autonomous vehicle is required. That is, the processor 114 may determine a situation in which the vehicle cannot travel on an existing path due to a driving situation or an emergency situation as a situation requiring the remote control, and may request remote control to the control system 200.

The processor 114 may transmit vehicle data for remote control to the control system 200, and when receiving a remote control command for remote control from the control system 200, may generate and follow a path based on the received remote control command. In the instant case, the vehicle data may include vehicle position information (e.g., vehicle coordinates), image information around the vehicle, information around the vehicle (e.g., obstacles, moving vehicle information, stationary vehicle information, fixed objects), and the like.

Furthermore, the remote control command may include at least one of ignoring a misrecognized object, changing a lane, ignoring a maximum road speed, ignoring a traffic signal, or responding to a hand signal.

The processor 114 requests remote control to the control system 200 when remote control of the autonomous vehicle is required, and when receiving a driving path stored during previous remote control from the control system 200, may follow and control the received driving path.

When requesting the remote control to the control system 200, the processor 114 may transmit at least one of the vehicle position information, the image information around the vehicle, or the information around the vehicle to the control system 200 through the communication unit 111.

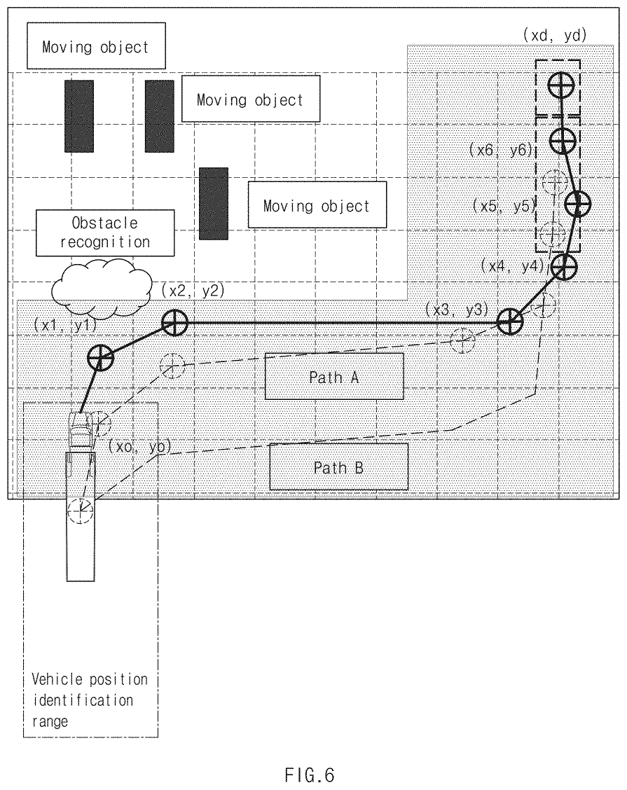

The processor 114 may determine a drivable area based on the driving path received from the control system 200. Furthermore, the processor 114 may modify the driving path received from the control system 200 based on information of the host vehicle and a possibility of collision. This will be described in detail with reference to FIG. 6.

When receiving a remote control command from the control system 200, the processor 114 generates a path based on the received remote control command to follow and control the generated path, and when the remote control ends, may transmit the driving path to the control system 200.

The sensing device 120 may include one or more sensors that detect an obstacle, e.g., a preceding vehicle, positioned around the host vehicle and measure a distance with the obstacle and/or a relative speed thereof.

The sensing device 120 may include a plurality of sensors to detect an external object of the vehicle, to obtain information related to a position of the external object, a speed of the external object, a moving direction of the external object, and/or a type of the external object (e.g., vehicles, pedestrians, bicycles or motorcycles, etc.). To the present end, the sensing device 120 may include an ultrasonic sensor, a radar, a camera, a laser scanner, and/or a corner radar, a Light Detection and Ranging (LiDAR), an acceleration sensor, a yaw rate sensor, a torque measurement sensor and/or a wheel speed sensor, a steering angle sensor, etc.

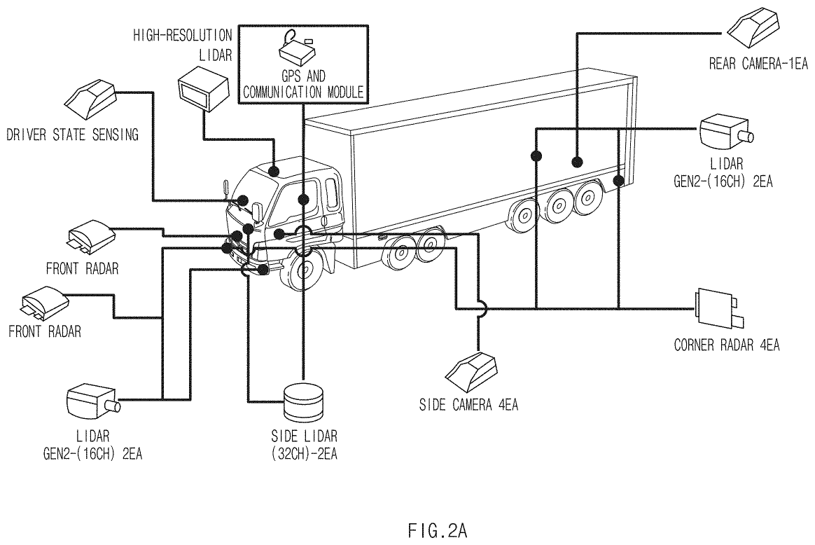

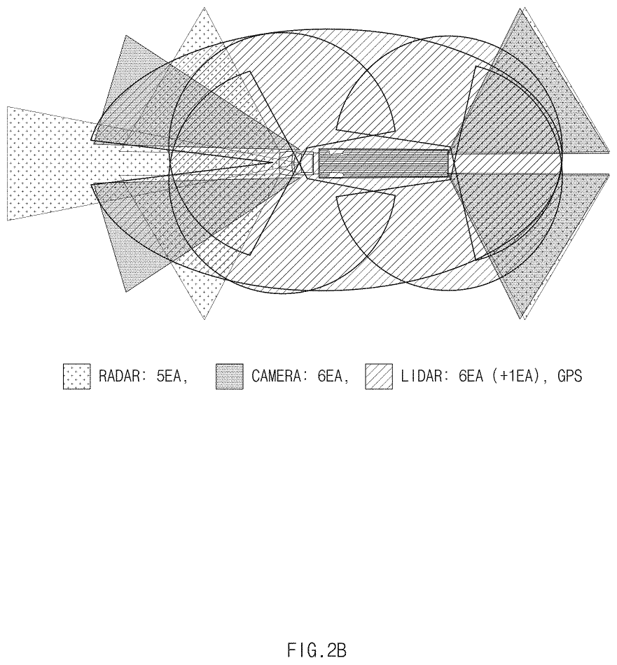

FIG. 2A illustrates a view for describing a sensing device of an autonomous vehicle according to various exemplary embodiments of the present invention, and FIG. 2B illustrates a sensing range of a sensing device of an autonomous vehicle according to various exemplary embodiments of the present invention.

Referring to FIG. 2A, the sensing device 120 may include a front radar mounted on the front of the vehicle, a Light Detection and Ranging (LiDAR), a side LiDAR, a side camera, a corner radar, a high-resolution LiDAR, a rear camera, a rear LiDAR, etc. Furthermore, referring to FIG. 2B, a surrounding situation may be detected through radars, cameras, and LiDARs of the front, rear, and side of the vehicle.

The steering control device 130 may be configured to control a steering angle of a vehicle, and may include a steering wheel, an actuator interlocked with the steering wheel, and a controller configured for controlling the actuator.

The braking control device 140 may be configured to control braking of the vehicle, and may include a controller that is configured to control a brake thereof.

The engine control device 150 may be configured to control engine driving of a vehicle, and may include a controller that is configured to control a speed of the vehicle.

When receiving a remote control request from the autonomous vehicle 100, the control system 200 may determine whether there is a previous remote control history that overlaps with the remote control request, and when there is the previous remote control history, may transmit the driving path corresponding to the previous remote control history to the autonomous vehicle 100.

The control system 200 may include a communication device 211, a storage 212, an interface device 213, and a processor 214.

The communication device 211 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, Local Interconnect Network (LIN) communication, flex-ray communication, Ethernet communication, and the like.

Furthermore, the communication device 211 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like. For example, the communication device 211 may perform wireless communication with the vehicle 100, may receive a remote control request from the vehicle 100, and may transmit an existing driving path or a remote control command to the vehicle 100.

The storage 212 may store vehicle data received from the vehicle 100, and data and/or algorithm required for the processor 214 to operate, and the like.

As an example, the storage 212 may store a vehicle path received from the vehicle 100, image data photographed through a camera, a remote control command selected by an operator, and the like.

The storage 212 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 213 may include an input means configured for receiving a control command from an operator and an output means for outputting an operation state of the control system 200 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display. For example, the interface device 213 may display map information in which a driving path of the vehicle, a current position of the vehicle, information related to surrounding objects, etc. are marked based on vehicle data received from the vehicle 100. For example, the interface device 213 may include a personal computer (PC), a notebook computer, a tablet, and the like.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

The processor 214 may be electrically connected to the communication device 211, the storage 212, the interface device 213, and the like, may electrically control each component, and may be an electrical circuit that executes software commands, performing various data processing and determinations described below.

The processor 214 may process a signal transferred between components of the control system 200, and may perform overall control such that each of the components can perform its function normally. The processor 214 may be implemented in a form of hardware, software, or a combination of hardware and software, or may be implemented as microprocessor.

When receiving a remote control request from the autonomous vehicle 100, the processor 214 may determine whether there is a previous remote control history overlapping within a predetermined distance from the vehicle 100 requesting remote control, and when there is the overlapping previous remote control history, may transmit a driving path corresponding to the overlapping previous remote control history to the autonomous vehicle 100.

When receiving a remote control request from the autonomous vehicle 100, the processor 214 may generate a remote control command list based on vehicle data received from the autonomous vehicle 100.

The processor 214 may mark a current position of the autonomous vehicle, surrounding object information, and a vehicle path on the map to display it on the screen through the interface device 213.

The processor 214 may receive vehicle position information, image information around the vehicle, and information around the vehicle from the vehicle 100 requesting remote control.

The processor 214 may determine whether there is a previous remote control history within a predetermined distance from a current position of the vehicle requesting remote control or at a same position as a current position of the vehicle.

The processor 214 may compare obstacle information around the vehicle requesting remote control with obstacle information stored in the previous remote control hi story.

The processor 214 may determine whether a fixed object or a moving object is present on a driving path stored in the previous remote control history.

The processor 214 may determine that the remote control request and the previous remote control history overlap with each other when the obstacle information around the vehicle requesting remote control matches the obstacle information stored in the previous remote control history, and the fixed object or the moving object is not present on the driving path stored in the previous remote control history.

When the moving object exists, the processor 214 may determine whether the moving object is movable in the future. That is, the processor 214 may determine whether the moving object is movable by determining whether there is a history of movement of the moving object while the moving object is stopped.

In the instant case, although the moving object exists, when it is determined that the moving object is movable in the future, the processor 214 may determine that the remote control request and the previous remote control history overlap with each other.

Accordingly, in the case where there is the previous remote control history within the predetermined distance from the current position of the vehicle 100 requesting remote control, the processor 214 may determine that the remote control request and the previous remote control history overlap with each other when the obstacle information around the vehicle requesting remote control matches the obstacle information stored in the previous remote control history, the fixed object or the moving object is not present on the driving path stored in the previous remote control history, the driving path is currently drivable, and there is a moving object which may move in the future on the driving path stored in the previous remote control history. Accordingly, when it is determined that the current remote control request and the previous remote control history overlap with each other, that is, there is a remote control history that overlaps with the current requested remote control request, the processor 214 enables the vehicle 100 to continue autonomous driving depending on the driving path received from the control system 20 by transmitting the driving path stored in the overlapped remote control history to the vehicle 100 without a separate remote control command,

When there is a plurality of previous remote control histories, the processor 214 may set a higher priority for a latest driving path, a path with a shortest driving time, and a driving path of a same vehicle type as that of the vehicle requesting remote control, and may provide a driving path with the higher priority to the vehicle 100.

The processor 214 may store the driving path in the storage 112 upon receiving the driving path from the vehicle 100 after the remote driving is terminated. In the instant case, the processor 214 may map vehicle data (e.g., vehicle type and a position at which the remote control is requested) of the vehicle requesting remote control and the driving path to store it.

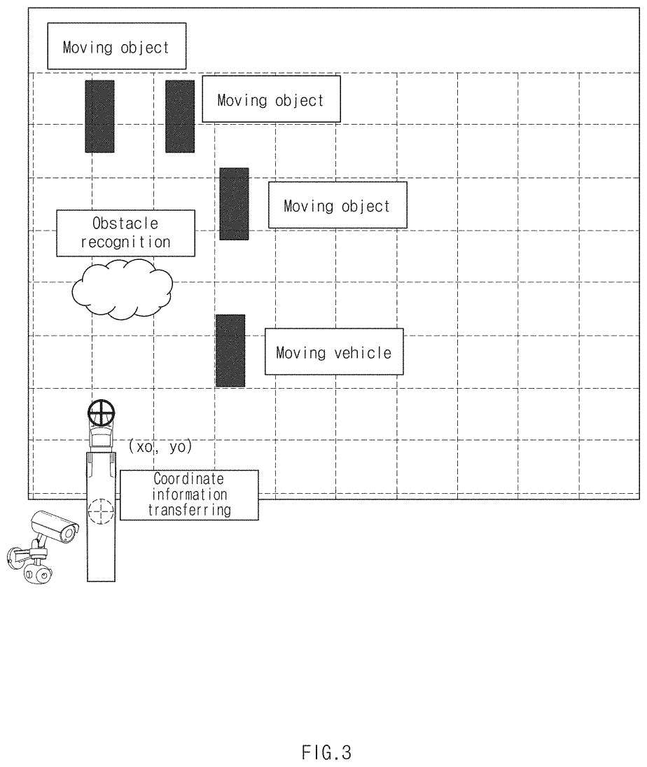

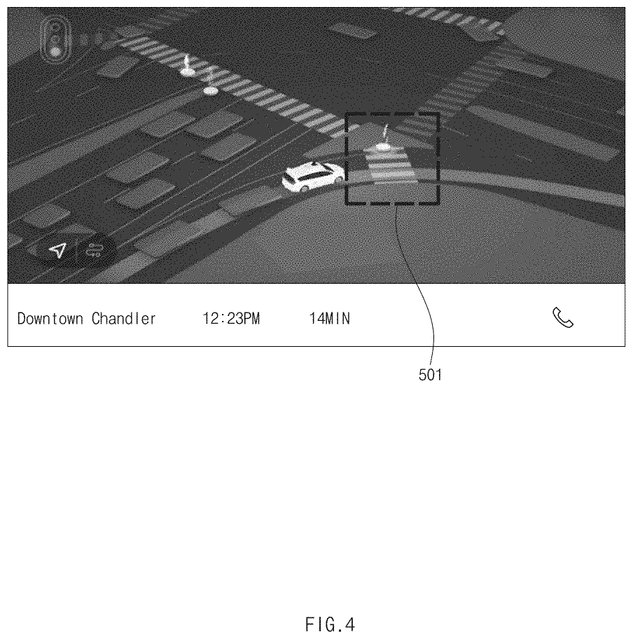

FIG. 3 illustrates a view for describing a process of determining whether to request remote control of an autonomous vehicle according to various exemplary embodiments of the present invention, and FIG. 4 illustrates a view for describing an example of a screen which is displayed in a control system based on information received from an autonomous vehicle according to various exemplary embodiments of the present invention.

Referring to FIG. 3, the vehicle 100 transmits vehicle position information (e.g., vehicle coordinates), image information around the vehicle, information around the vehicle (e.g., an obstacle, a moving vehicle, a stationary vehicle, or a fixed object), and/or the like to the control system 200.

Accordingly, the control system 200 may construct and display a 3D screen as shown in FIG. 4 based on the vehicle position information, the image information around the vehicle, and the information around the vehicle, received from the vehicle 100, to enable an operator to grasp a situation at a glance. In FIG. 4, a point 501 where a recognition error occurred is illustrated.

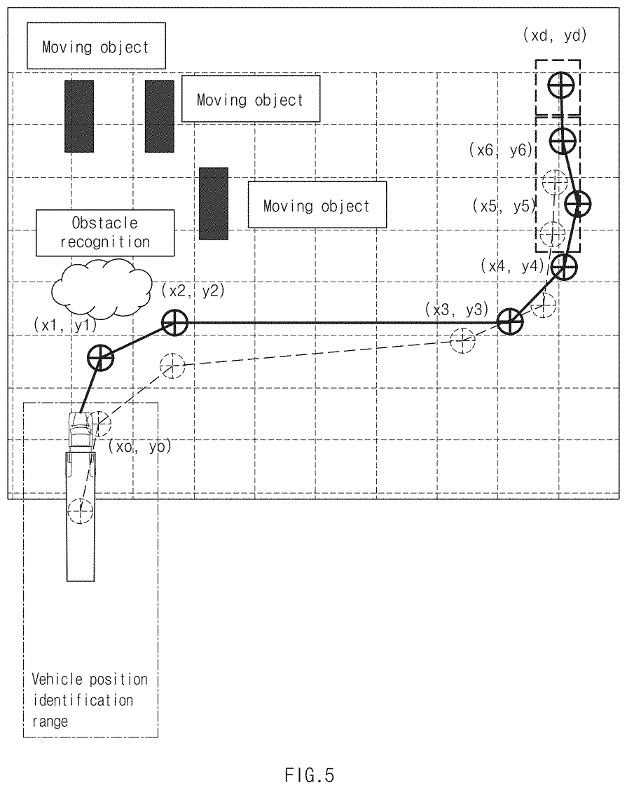

FIG. 5 illustrates a view for describing a process of checking duplicate remote driving data by a control system according to various exemplary embodiments of the present invention.

Referring to FIG. 5, when receiving a remote control request from the vehicle 100, the control system 200 checks a same remote control history within a predetermined distance (within a vehicle position identification range) from a current position of the vehicle 100. For example, the control system 200 may check the previous remote control history in a radius of 100 meters from the current position of the vehicle 100. Furthermore, when receiving a remote obstacle avoidance control request from the vehicle 100, the control system 200 may check whether there is a remote control history of previously performing remote obstacle avoidance control within a predetermined distance from the current position of the vehicle 100.

The control system 200 determines whether a position of the obstacle requested to be avoided from the vehicle 100 is the same as that of the obstacle to be avoided in the path pre-stored in the control system 200. That is, when the vehicle 100 recognizes an obstacle while driving, determines that autonomous driving control cannot be continued, and requests remote control to the control system 200, the vehicle 100 transmits obstacle recognition information to the control system 200 to request remote control. Accordingly, the control system 200 searches for a history of remote control near the current position of the vehicle 100 in the past, and when an existing path is stored, determines whether information (e.g., position, size, etc.) of an obstacle received from the vehicle 100 is the same as information related to an obstacle to be avoided in pre-stored path information.

When the position of the obstacle requested to be avoided from the vehicle 100 is the same as that of the obstacle to be avoided in the path pre-stored in the control system 200, the control system 200 determines whether there are no other obstacles on the pre-stored path and is currently in a drivable state. For example, the control system 200 may determine whether a pre-stored path is currently drivable by determining whether a road is under construction, a traffic accident occurs, or severe traffic congestion occurs.

Furthermore, the control system 200 may determine whether there is a moving object, i.e., a vehicle on the pre-stored path, and when there is a vehicle in the pre-stored path, may determine whether the vehicle is movable in the future. That is, the control system 200 may determine the vehicle 100 which is movable in the future when there is a history of movement of a vehicle existing in the pre-stored path while it is stopped.

The control system 200 enables the vehicle 100 to continuously perform autonomous driving depending on the previously stored driving path by transferring the pre-stored driving path to the vehicle 100 without a separate remote control when there is the same remote control history within the predetermined distance from the current position of the vehicle 100, there are no obstacles on the driving path stored in the previous remote control history, and an obstacle on the pre-stored driving path, e.g., the vehicle, is movable in the future although the obstacle on the pre-stored path exists.

Furthermore, when there is a plurality of remote control histories within a predetermined distance from the current position of the vehicle 100, the control system 200 may select a most recent driving path or a shortest driving path to provide it to the vehicle 100.

Furthermore, when there is a plurality of remote control histories within a predetermined distance from the current position of the vehicle 100, there is a plurality of paths, and driving times of the plurality of paths are the same, the control system 200 provides a driving path of a same vehicle type as that of the vehicle 100 requesting a current remote control with a highest priority to the vehicle 100.

FIG. 6 illustrates a view for describing a process of performing obstacle avoidance driving based on a path received from an autonomous vehicle according to various exemplary embodiments of the present invention.

Referring to FIG. 6, when the vehicle 100 discovers an obstacle during autonomous driving, requests remote control to the control system 200 to avoid the obstacle, and transfers a pre-stored driving path (path A) depending on a previous remote control history to the vehicle 100, the vehicle 100 may be enabled to continue to perform the autonomous driving based on the path A.

In the instant case, when receiving the pre-stored driving path (path A) from the control system 200, the vehicle 100 compares vehicle type information stored along with the corresponding path A in the control system 200 with vehicle type information of the host vehicle. In the instant case, the vehicle type information may include an overall width and an overall length.

Next, the vehicle 100 may select a drivable area based on the path A received from the control system 200 using a sensing result of the sensing device 120.

Next, the vehicle 100 may modify the driving path from the path A to a path B in a range where there is no risk of a collision accident in consideration of the information (overall width and overall length) of the host vehicle.

Accordingly, the vehicle 100 performs autonomous driving control on the path B and transmits information related to the path B to the control system 200.

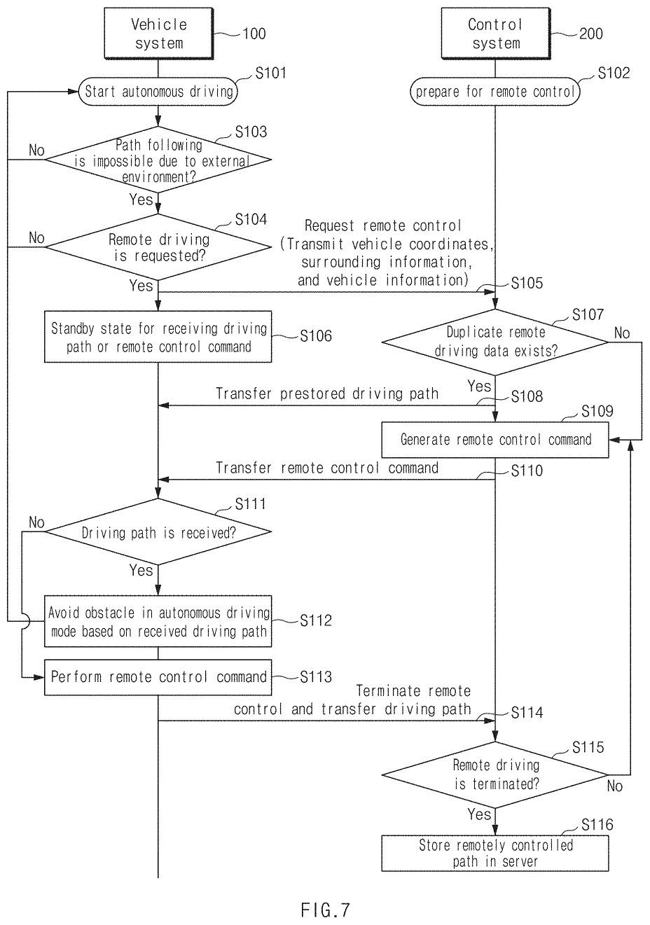

Hereinafter, a remote control method for an autonomous vehicle according to various exemplary embodiments of the present invention will be described in detail with reference to FIG. 7. FIG. 7 illustrates an autonomous control method for a vehicle according to various exemplary embodiments of the present invention.

Hereinafter, it is assumed that the autonomous driving control apparatus 110 of the vehicle 100 of FIG. 1 and the control system 200 perform processes of FIG. 7. Furthermore, in the description of FIG. 7, it may be understood that operations referred to as being performed by each system are controlled by a processor of each of the systems.

Referring to FIG. 7, the vehicle 100 starts autonomous driving (S101), and the control system 200 prepares for remote control (S102).

The vehicle 100 determines whether driving of a current path is impossible due to an external environment during autonomous driving (S103), and when the driving of the current path is impossible, determines whether remote driving should be requested (S104). That is, the vehicle 100 may determine that the remote control is required when the vehicle cannot normally follow a path to a destination while driving in the autonomous driving mode.

Accordingly, when a remote driving request is required, the vehicle 100 performs a remote control request to the control system 200 (S105), and enters a standby state for receiving a driving path or receiving a remote control command (S106). In the instant case, the vehicle 100 transmits vehicle data such as vehicle position information (coordinates), vehicle surrounding information (surrounding object information, obstacles, etc.), and vehicle information (e.g., overall length and overall width) together therewith when requesting the remote control.

Accordingly, the control system 200 determines whether duplicate remote driving data exists based on the vehicle data received from the vehicle 100 (S107).

That is, the control system 200 checks whether there is a same previous remote control record within a predetermined distance from the current position of the vehicle 100 based on the vehicle data received from the vehicle 100 (S107), and when the previous remote control record exists, transmits a previous remote control driving path to the vehicle 100 (S108).

In the instant case, the control system 200 may transfer a highest priority path to the vehicle 100 depending on priorities thereof when there is a plurality of same previous remote control records within a predetermined distance from the current position of the vehicle 100, or there is a plurality of driving paths during previous remote control.

The control system 200 may determine priorities among the driving paths based on a vehicle type, a driving time, and the like. For example, when a vehicle type of the vehicle which is a target of the driving paths is the same as that of the vehicle 100 requesting the remote control, a priority of the corresponding path may be set higher. Furthermore, it is possible to set a priority of a path having a short driving time to be higher among the driving paths.

Furthermore, the control system 200 may display vehicle data (a vehicle path, a vehicle position, surrounding objects, etc.) received from the vehicle 100, which is a remote control target, on a screen so that an operator can check it at a glance. That is, the control system 200 may display a map corresponding to the vehicle and a traveling path on a screen based on a current position of the vehicle 100.

When there is no duplicate remote control history in step S107, the control system 200 generates a remote control command corresponding to the remote control request of the vehicle 100 (S109) and transmits it to the vehicle 100 (S110). In the instant case, the remote control command may include, e.g., changing a lane, ignoring an obstacle, and the like.

The vehicle 100 determines whether a driving path or a remote control command has been received from the control system 200 (S111), and when the driving path is received from the control system 200, and may avoid an obstacle in an autonomous driving mode based on the received driving path (S112).

On the other hand, when the remote control command has been received from the control system 200, the vehicle 100 may generate a path depending on the received remote control command and follows the path (S113), and when the remote control is terminated, transmits a remote control termination notification and the driving path to the control system 200 (S114).

When receiving the remote control termination notification and the driving path, the control system 200 determines that the remote driving has terminated (S115), and stores the driving path of the vehicle 100 (S116).

Accordingly, when a remote control request is received from another vehicle in a position close to the vehicle 100 later, the control system 200 provide a previously stored driving path to the other vehicle by mapping and storing the vehicle data requested for remote control (vehicle position (coordinates), vehicle information (a vehicle type, an overall length, an overall width, etc.), vehicle surrounding information (obstacles, etc.)) and the path driven by the remote control.

Accordingly, according to various exemplary embodiments of the present invention, when the vehicle 100 performs a remote control request to the control system 200 during autonomous driving, following and control may be directly performed depending on a path provided by the control system 200 by extracting a previously duplicate remote control history and providing the vehicle 100 with a driving path during a previous duplicate remote control without a demand for the control system 200 to newly generate a remote control command a demand for the vehicle 100 to generate a new path depending on the remote control command, increasing user convenience and system reliability.

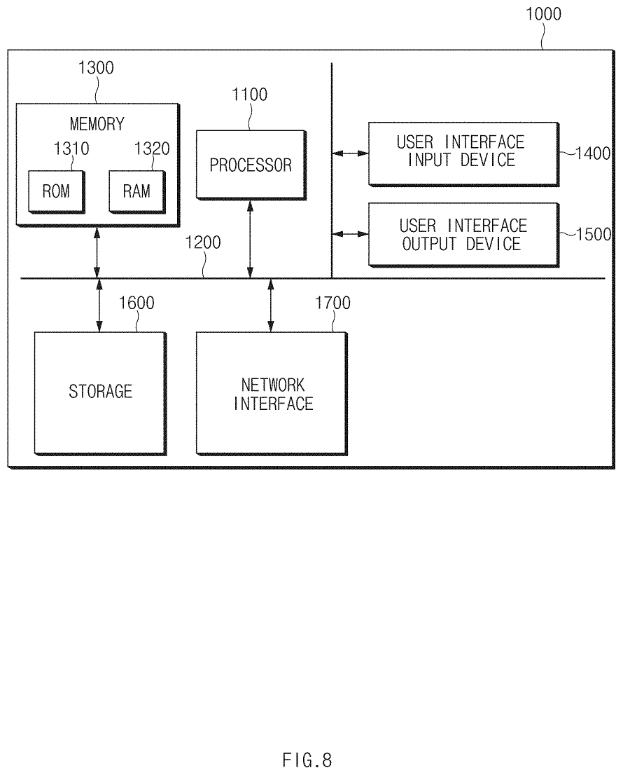

FIG. 8 illustrates a computing system according to various exemplary embodiments of the present invention.

Referring to FIG. 8, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, a EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An autonomous vehicle comprising:
an autonomous driving control apparatus including a processor that is configured to request remote control of the autonomous vehicle to a control system when the remote control of the autonomous vehicle is required, and when receiving a driving path stored during a previous remote control of the autonomous vehicle from the control system, to follow and control the received driving path.

2. The autonomous vehicle of claim 1, further including:
a communication device configured to communicate with the control system.

3. The autonomous vehicle of claim 2, wherein the processor is configured to transmit at least one of vehicle position information, vehicle surrounding image information, or vehicle surrounding information to the control system through the communication device when requesting the remote control to the control system.

4. The autonomous vehicle of claim 3, wherein the vehicle surrounding information includes at least one of obstacle information, moving vehicle information, or stationary vehicle information.

5. The autonomous vehicle of claim 1, wherein the processor is configured to determine a drivable area based on the driving path received from the control system.

6. The autonomous vehicle of claim 5, wherein the processor is configured to modify the driving path received from the control system according to information of a host vehicle and a possibility of collision.

7. The autonomous vehicle of claim 1, wherein the processor is configured to:
generate a path according to a remote control command to follow and control the generated path when receiving the remote control command from the control system, and
transmit the generated path to the control system when the remote control is terminated.

8. A control system comprising:
a processor configured to determine whether there is a previous remote control history of a vehicle overlapping within a predetermined distance from a current position of the vehicle requesting remote control thereof upon receiving a remote control request from the autonomous vehicle, and when there is the overlapping previous remote control history, to transmit a driving path corresponding to the overlapping previous remote control history to the autonomous vehicle.

9. The control system of claim 8, wherein the processor is configured to receive vehicle position information, vehicle surrounding image information, and vehicle surrounding information from the vehicle requesting the remote control.

10. The control system of claim 8, wherein the processor is configured to compare obstacle information around the vehicle requesting the remote control with obstacle information stored in the previous remote control history.

11. The control system of claim 10, wherein the processor is configured to determine whether a fixed object or a moving object exists on a driving path stored in the previous remote control history.

12. The control system of claim 11, wherein the processor, when the moving object exists on the driving path, determines whether the moving object is movable in the future.

13. The control system of claim 12, wherein the processor is configured to determine whether the moving object is movable by determining whether there is a history of movement of the moving object while the moving object is stopped.

14. The control system of claim 8, wherein when obstacle information around the vehicle requesting the remote control matches obstacle information stored in the previous remote control history, and a fixed object or a moving object does not exist on the driving path stored in the previous remote control history, the processor is configured to:
determine that the remote control request and the previous remote control history overlap with each other, and
transmit the driving path stored in the previous remote control history to the autonomous vehicle.

15. The control system of claim 14, wherein although the moving object exists, the processor is configured to:
determine that the moving object is movable in the future when there is a history of movement of the moving object while the moving object is stopped, and
determine that the remote control request and the previous remote control history overlap with each other.

16. The control system of claim 8, wherein
when there is the previous remote control history within the predetermined distance from the current position of the vehicle requesting the remote control,
when obstacle information around the vehicle requesting the remote control matches obstacle information stored in the previous remote control history,
when there is no fixed object on the driving path stored in the previous remote control history, and the driving path is currently drivable, and
when there is a moving object which is movable in the future on the driving path stored in the previous remote control history,
the processor is configured to:
determine that the remote control request and the previous remote control history overlap with each other, and
transmit the driving path stored in the previous remote control history to the autonomous vehicle.

17. The control system of claim 8, wherein when there is a plurality of previous remote control histories, the processor is configured to:
sets a higher priority for a latest driving path, a path with a shortest driving time, and a driving path of a same vehicle type as the driving path of the vehicle requesting the remote control.

18. The control system of claim 8, further including:
a storage configured to store a remote control history received from the autonomous vehicle after terminating the remote driving.

19. A remote control method for an autonomous vehicle, the remote control method comprising:
receiving, by a control system, a remote control request from the autonomous vehicle;
determining, by the control system, whether there is a previous remote control history overlapping within a predetermined distance from the vehicle requesting remote control; and
transmitting, by the control system, a driving path corresponding to the overlapping previous remote control history to the autonomous vehicle when the overlapping previous remote control history exists.

20. The remote control method of claim 19, wherein the determining of whether there is the overlapping previous remote control history includes:
when there is the previous remote control history within the predetermined distance from a current position of the vehicle making the remote control request,
when obstacle information around the vehicle making the remote control request matches obstacle information stored in the previous remote control history,
when there is no fixed object on a driving path stored in the previous remote control history, and the driving path is currently drivable, and
when there is a moving object which is movable in the future on the driving path stored in the previous remote control history,
determining that the remote control request and the previous remote control history overlap with each other; and
transmitting the driving path stored in the previous remote control history to the autonomous vehicle.
